(19) United States
(12) Patent Application Publication
(10) Pub. No.: US 2025/0029760 A1
(43) Pub. Date: Jan. 23, 2025

(54) COIL DEVICE

(71) Applicant: TDK CORPORATION, Tokyo (JP)

(72) Inventors: Minwoo SONG, Tokyo (JP); Setu TSUCHIDA, Yurihonjo-city (JP); Shun KOSUGI, Tokyo (JP); Takashi KADOYA, Tokyo (JP); Takayuki ITO, Tokyo (JP); Masaomi ENOKI, Tokyo (JP); Hiroshi TAKAHASHI, Tokyo (JP)

(73) Assignee: TDK CORPORATION, Tokyo (JP)

(21) Appl. No.: 18/755,948

(22) Filed: Jun. 27, 2024

(30) Foreign Application Priority Data
Jul. 18, 2023 (JP) 2023-117017

(51) Int. Cl. H01F 5/04; H01F 3/10; H01F 27/28; H01F 27/29

(52) U.S. Cl. CPC H01F 5/04; H01F 3/10; H01F 27/2828; H01F 27/29

(57) ABSTRACT

A coil device includes a wire, a core, and a terminal fitting. The wire includes a winding portion and a lead-out portion drawn out from the winding portion. The core includes a shaft and a flange at one end of the shaft. The shaft has the winding portion wound around. The terminal fitting includes a mounting portion connectable to a mounting substrate, a wire connecting portion connected to the lead-out portion, and an intermediate portion connecting the mounting portion and the wire connecting portion. The mounting portion and the wire connecting portion are disposed over a mounting surface of the flange. The intermediate portion has a route extending over an end surface of the flange and a side surface of the flange to connect the mounting portion and the wire connecting portion.

### TECHNICAL FIELD

The present invention relates to a coil device including a terminal fitting.

### BACKGROUND

Various techniques have been suggested in relation to a coil device including a terminal fitting as described in, for example, Patent Document 1. A terminal fitting of a coil device of Patent Document 1 includes a mounting portion and a wire connecting portion.

The mounting portion is a portion configured to be connected to a land pattern of a mounting substrate using, for example, solder. The wire connecting portion is a portion to which a lead-out portion of a wire is connected using, for example, laser welding.
Patent Document 1: JP Patent Application Laid Open No. 2020-074459

### SUMMARY

As techniques of connecting the lead-out portion to the wire connecting portion, known are various techniques such as soldering, laser welding, thermocompression bonding, and resistance brazing. When the lead-out portion is connected to the wire connecting portion using these techniques, heat is transferred from the wire connecting portion to the mounting portion, and the temperature of the mounting portion rises. Thus, joinability of the mounting portion with respect to the mounting substrate may decrease, and joint strength between the mounting portion and the mounting substrate may decrease. Consequently, mounting defects may occur, such as detachment of the coil device from the mounting substrate.

The present invention has been achieved in view of such circumstances. It is an object of the present invention to provide a coil device having high quality of joining between a mounting portion and a mounting substrate.

To achieve the above object, a coil device according to the present invention includes: a wire including a winding portion and a lead-out portion drawn out from the winding portion;
a core including a shaft and a flange at one end of the shaft, the shaft having the winding portion wound around; and
a terminal fitting including a mounting portion connectable to a mounting substrate, a wire connecting portion connected to the lead-out portion, and an intermediate portion connecting the mounting portion and the wire connecting portion,
wherein
the mounting portion and the wire connecting portion are disposed over a mounting surface of the flange; and
the intermediate portion has a route extending over an end surface of the flange and a side surface of the flange to connect the mounting portion and the wire connecting portion.

In the coil device according to the present invention, the intermediate portion has the route extending over the end surface of the flange and the side surface of the flange to connect the mounting portion and the wire connecting portion. That is, instead of extending along a shortest route between the mounting portion and the wire connecting portion (a route along the mounting surface), the intermediate portion extends along a route circumventing the shortest route (a route extending over the end surface and the side surface of the flange). Thus, compared to a situation in which the intermediate portion extends along the shortest route, the intermediate portion has a longer length along its extending direction, and the distance between the mounting portion and the wire connecting portion via the intermediate portion is increased. This reduces the amount of heat transfer from the wire connecting portion to the mounting portion, mitigating the temperature rise of the mounting portion. Thus, joinability of the mounting portion with respect to the mounting substrate is improved, which can increase quality of joining between the mounting portion and the mounting substrate.

Also, for example, when the mounting portion is adhered to the mounting surface of the flange, mitigation of the temperature rise of the mounting portion makes an adhesive layer between the mounting portion and the mounting surface of the flange be less readily degraded. This improves joinability of the mounting portion with respect to the mounting surface, improving quality of joining between the mounting portion and the mounting surface.

The flange may have a depression in the mounting surface; the mounting portion may be outside the depression; and the wire connecting portion may at least partly be inside the depression. In this situation, when the mounting portion is connected to the mounting substrate, the wire connecting portion is disposed apart from the mounting substrate, and the wire connecting portion is less readily in contact with the mounting substrate. Thus, short circuits between the wire connecting portion and the mounting substrate can be prevented.

The lead-out portion may be at least partly disposed between the wire connecting portion and the mounting surface. In this situation, for example, when the lead-out portion is connected to the wire connecting portion, the wire connecting portion or the mounting surface can prevent misalignment of the lead-out portion due to its elasticity.

This allows the lead-out portion to be connected to a desired point in the wire connecting portion, improving quality of joining between the lead-out portion and the wire connecting portion.

The wire connecting portion may include a first holding-down piece and a second holding-down piece; the first holding-down piece may hold the lead-out portion down towards the mounting surface; the second holding-down piece may hold the lead-out portion down towards the mounting surface at a location between the first holding-down piece and the end surface of the flange; and the second holding-down piece may be connected to the lead-out portion at the location. For example, holding the lead-out portion down towards the mounting surface using the first holding-down piece before the lead-out portion is connected to the second holding-down piece can reduce variety in positions of the lead-out portion to connect the lead-out portion to a desired point in the second holding-down piece. Also, holding the lead-out portion down towards the mounting surface using the second holding-down piece allows the lead-out portion to connect to the second holding-down piece while contact between the lead-out portion and the second holding-down piece is ensured.

The first holding-down piece and the second holding-down piece may have a crimping structure. In this situation, crimping the first holding-down piece and the second holding-down piece allows the lead-out portion to be easily held down towards the mounting surface.

The wire connecting portion may have a terminal groove accommodating at least a part of the lead-out portion, an inner surface opposing the mounting surface, and an outer surface opposite the inner surface; and the terminal groove may be recessed from the inner surface towards the outer surface. In this situation, the terminal groove helps positioning of the lead-out portion, reducing variety in positions of the lead-out portion relative to the wire connecting portion. This allows the lead-out portion to be connected to a desired point in the wire connecting portion, improving quality of joining between the lead-out portion and the wire connecting portion.

The flange may have a flange groove accommodating at least a part of the lead-out portion; and the flange groove may oppose the wire connecting portion. In this situation, the flange groove helps positioning of the lead-out portion, reducing variety in positions of the lead-out portion relative to the wire connecting portion. This allows the lead-out portion to be connected to a desired point in the wire connecting portion, improving quality of joining between the lead-out portion and the wire connecting portion.

The terminal fitting may include a first terminal fitting and a second terminal fitting; the first terminal fitting may be closer to one side surface of the flange; and the second terminal fitting may be closer to an other side surface of the flange. With the flange being provided with the two terminal fittings, the coil device has an improved mounting stability when mounted on the mounting substrate.

The coil device may further include a plate-like core attached to the core; the flange may include a non-mounting surface opposite the mounting surface; and the plate-like core may be joined to the non-mounting surface. In this situation, the core and the plate-like core form a closed magnetic circuit, improving magnetic properties of the coil device.

### BRIEF DESCRIPTION OF THE DRAWING(S)

FIG. 1 is a perspective view of a coil device according to a first embodiment of the present invention.

FIG. 2 is an exploded perspective view of the coil device shown in FIG. 1.

FIG. 3 is a perspective view of a core shown in FIG. 2.

FIG. 4 is a perspective view of terminal fittings shown in FIG. 2.

FIG. 5 is a side elevational view of the coil device shown in FIG. 1 viewed from a Y-axis direction.

FIG. 6 is a side elevational view of the coil device shown in FIG. 1 viewed from an X-axis direction.

FIG. 7 is a perspective view of a coil device according to a second embodiment of the present invention.

FIG. 8 is a perspective view of terminal fittings shown in FIG. 7.

FIG. 9 is an exploded perspective view of a coil device according to a third embodiment of the present invention.

FIG. 10 is a perspective view of a core shown in FIG. 9.

FIG. 11 is a perspective view of a coil device according to a fourth embodiment of the present invention.

FIG. 12 is a perspective view of a core shown in FIG. 11.

FIG. 13 is a perspective view of terminal fittings shown in FIG. 11.

FIG. 14 is a perspective view of a coil device according to a fifth embodiment of the present invention.

FIG. 15 is a perspective view of terminal fittings shown in FIG. 14.

### DETAILED DESCRIPTION

Hereinafter, embodiments of the present invention are described with reference to the drawings. Illustrations in the drawings are only schematically and exemplarily provided for understanding of the present invention; and the appearance, dimensional ratios, etc. may be different from the actual ones. The present invention is not limited to the following embodiments.

### First Embodiment

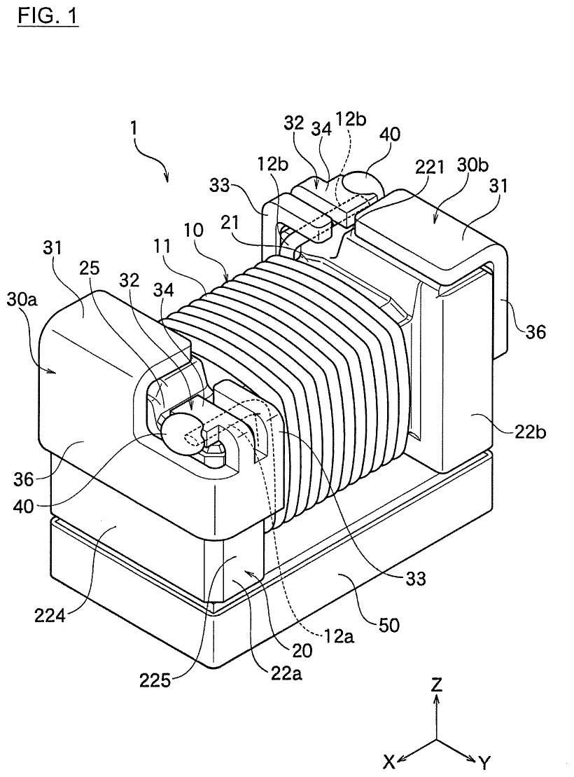

A coil device 1 shown in FIG. 1 functions as, for example, an inductor and may be included in a power supply or the like of electronic equipment. The coil device 1 includes a wire 10, a core 20, and terminal fittings 30a and 30b. The coil device 1 includes a plate-like core 50 in addition to these members; however, the plate-like core 50 is not mandatory.

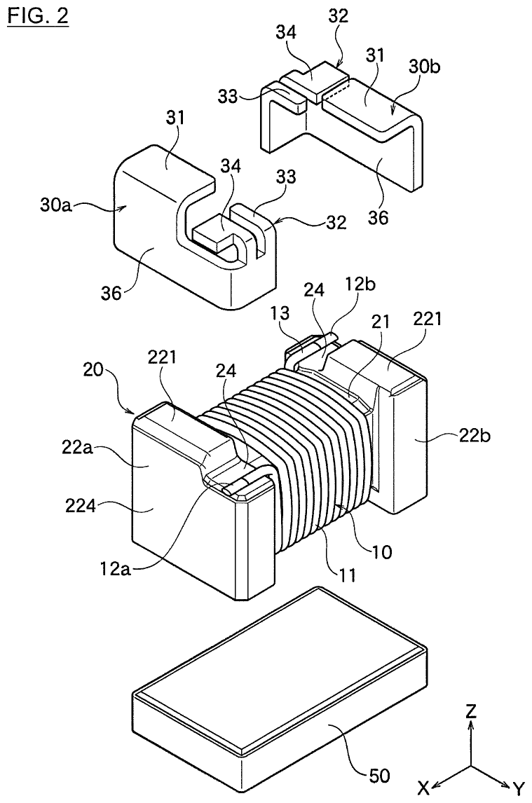

As shown in FIG. 2, the wire 10 includes a winding portion 11, which is wound in a coil shape, and lead-out portions 12a and 12b, which are drawn out from the winding portion 11. The wire 10 is any wire and may be an insulation coated wire, in which a copper wire or the like is coated with an insulating film 13. The wire 10 may have any diameter; and the diameter is, for example, 10 to 300 m. The film 13 is removed at respective tips of the lead-out portions 12a and 12b.

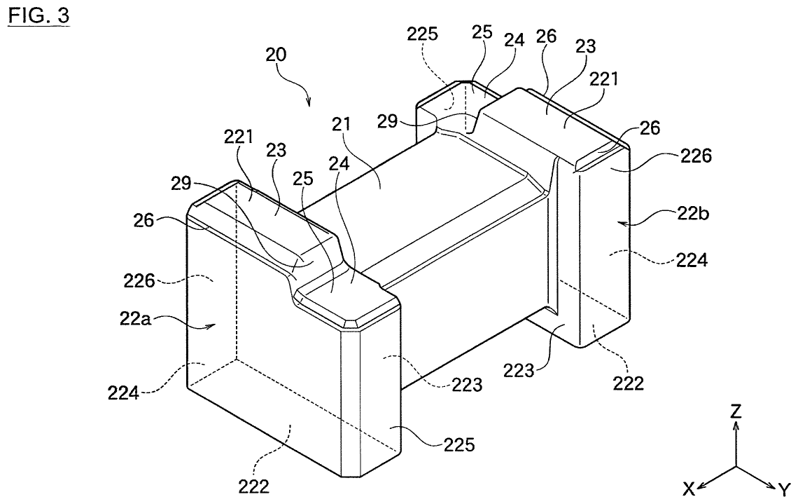

The core 20 is a drum core and includes a shaft 21 and flanges 22a and 22b. The core 20 is a magnetic material and is composed of, for example, a ferrite composition, a metal composition, or a composite composition including these and resin. Around an outer circumferential surface of the shaft 21, the wire 10 is wound to form the winding potion 11. Between an end of the winding portion 11 in its winding axis direction and the flange 22a is a gap. Between another end of the winding portion 11 in its winding axis direction and the flange 22b is a gap. As shown in FIG. 3, the shaft 21 has an octagonal sectional shape perpendicular to an axial direction of the shaft 21; however, the sectional shape may be, for example, quadrilateral, hexagonal, polygonal, circular, or oval.

The flange 22a is at one end of the shaft 21 in the axial direction, and the flange 22b is at the other end of the shaft 21 in the axial direction. Each of the flanges 22a and 22b includes a mounting surface 221, a non-mounting surface 222, an inner end surface 223, an outer end surface 224, a first side surface 225, and a second side surface 226. The mounting surface 221 and the non-mounting surface 222 face each other. The inner end surface 223 and the outer end surface 224 face each other. The first side surface 225 and the second side surface 226 face each other.

In FIG. 2 and other figures, an X-axis is an axis extending along the direction in which the inner end surface 223 and the outer end surface 224 face each other. A Y-axis is an axis extending along the direction in which the first side surface 225 and the second side surface 226 face each other. A Z-axis is an axis extending along the direction in which the mounting surface 221 and the non-mounting surface 222 face each other. The X-axis, the Y-axis, and the Z-axis are mutually perpendicular. The X-axis corresponds to the axial direction of the shaft 21.

Each of the flanges 22a and 22b has a depression 25 in the mounting surface 221. The depression 25 in the mounting surface 221 is closer to the first side surface 225. The mounting surface 221 is depressed by the depression 25 at a side closer to the first side surface 225. The depression 25 may have any depth. The depth is so deep that a wire connecting portion 32 of the terminal fitting 30a or 30b described later is accommodable.

The mounting surface 221 includes a first region 23 without the depression 25 and a second region 24 with the depression 25. The first region 23 and the second region 24 are flat surfaces and are adjacent to each other along the Y-axis. The length of the first region 23 in the Y-axis direction is longer than the length of the second region 24 in the Y-axis direction but may be equivalent to or shorter than the length of the second region 24 in the Y-axis direction.

Between the first region 23 and the second region 24 is a difference in level along the Z-axis. A step 29 connecting the first region 23 and the second region 24 extends from one end to the other end of the mounting surface 221 in the X-axis direction. Respective peripheral portions of the first region 23 and the second region 24 are provided with chamfering portions 26 to prevent cracks or chips.

The depression 25 of the flange 22a and the depression 25 of the flange 22b are located opposite each other in the Y-axis direction relative to the shaft 21. Thus, when the coil device 1 is mounted on a mounting substrate (not shown in the drawings), stability of the coil device 1 with respect to the mounting substrate is higher compared to a situation in which the depression 25 of the flange 22a and the depression 25 of the flange 22b are located on the same side of the Y-axis direction relative to the shaft 21. Note that the depression 25 of the flange 22a and the depression 25 of the flange 22b may be located on the same side of the Y-axis direction relative to the shaft 21.

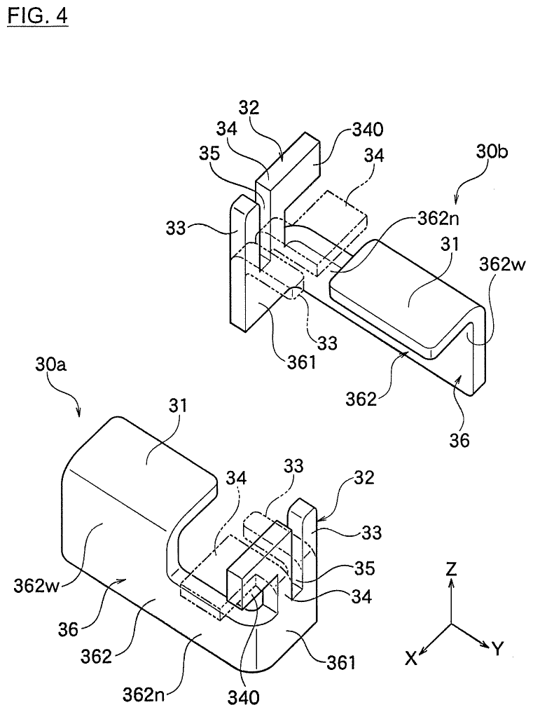

As shown in FIG. 4, the terminal fitting 30a includes a mounting portion 31, a wire connecting portion 32, and an intermediate portion 36. The terminal fitting 30b also includes a mounting portion 31, a wire connecting portion 32, and an intermediate portion 36. The terminal fittings 30a and 30b have the same shape but may have different shapes. The terminal fittings 30a and 30b are composed of a conductor (e.g., metal). Surfaces of the terminal fittings 30a and 30b are entirely or locally provided with a plating film made from Sn, Ni, or the like. The terminal fittings 30a and 30b may have any thickness; and the thickness may be 50 to 300 m. The mounting portion 31, the wire connecting portion 32, and the intermediate portion 36 have the same thickness but may have different thicknesses.

The mounting portion 31 is a portion connectable to a mounting substrate. The mounting portion 31 has a surface parallel to the first region 23 of the mounting surface 221 (FIG. 3). As shown in FIG. 1, the mounting portion 31 is disposed in the first region 23. That is, the mounting portion 31 is disposed over the mounting surface 221, at a location different from the depression 25.

In a state in which the terminal fittings 30a and 30b are fixed to the flanges 22a and 22b respectively, each mounting portion 31 is adhered to the corresponding first region 23 (FIG. 3) using an adhesive (e.g., epoxy based adhesive). This forms an adhesive layer between the mounting portion 31 and the first region 23, allowing prevention of detachment of the terminal fittings 30a and 30b. The mounting portion 31 may be connected to a land pattern of the mounting substrate using, for example, solder or a conductive adhesive.

In the Y-axis direction, the mounting portion 31 may have any length that is longer than half the length of the mounting surface 221 (FIG. 3) in the Y-axis direction. In this situation, stability of the coil device 1 with respect to the mounting substrate is improved when the mounting portion 31 is connected to the mounting substrate.

As shown in FIG. 4, the wire connecting portion 32 is a portion connected to the lead-out portion 12a or 12b. The lead-out portion 12a may be connected to the wire connecting portion 32 using, for example, soldering, laser welding, thermocompression bonding, ultrasonic bonding, resistance brazing, or UV curing resin bonding. The same applies to the lead-out portion 12b.

In the present embodiment, the lead-out portions 12a and 12b are connected to the respective wire connecting portions 32 using laser welding. Thus, as shown in FIG. 1, a fusion zone (weld bead) 40 is formed where the wire connecting portion 32 of the terminal fitting 30a and the lead-out portion 12a connect. Similarly, a fusion zone 40 is formed where the wire connecting portion 32 of the terminal fitting 30b and the lead-out portion 12b connect. The lead-out portions 12a and 12b are integrated with the respective wire connecting portions 32 using the fusion zones 40.

The wire connecting portion 32 is at least partly disposed in the second region 24 (FIG. 3) of the mounting surface 221. The wire connecting portion 32 is at least partly inside the depression 25. Thus, when the mounting portion 31 is connected to the mounting substrate, the wire connecting portion 32 is disposed apart from the mounting substrate, and the wire connecting portion 32 is less readily in contact with the mounting substrate.

This can prevent short circuits between the wire connecting portion 32 and the mounting substrate. The wire connecting portion 32 is partly disposed over the first side surface 225; however, the wire connecting portion 32 may entirely be disposed in the second region 24. The wire connecting portion 32 is not adhered to the second region 24 using an adhesive, and a gap is provided between the wire connecting portion 32 and the second region 24.

As shown in FIG. 4, the wire connecting portion 32 includes a first holding-down piece 33 and a second holding-down piece 34 and has a gap 35 between the first holding-down piece 33 and the second holding-down piece 34. The first holding-down piece 33 and the second holding-down piece 34 are located opposite each other with the gap 35 therebetween. The first holding-down piece 33 is located closer to the inner end surface 223 (FIG. 3) of the flange 22a or 22b. The second holding-down piece 34 is located closer to the outer end surface 224 (FIG. 3) of the flange 22a or 22b.

The first holding-down piece 33 and the second holding-down piece 34 are bendable and have a crimping structure. FIG. 4 shows a state of the first holding-down piece 33 before being bent in solid lines and a state of the first holding-down piece 33 after being bent in dashed-and-double-dotted lines. FIG. 4 also shows a state of the second holding-down piece 34 before being bent in solid lines and a state of the second holding-down piece 34 after being bent in dashed-and-double-dotted lines.

The first holding-down piece 33 is composed of a plate piece having an elongated shape and is bendable substantially at right angles from a state of being straight along the Z-axis. The second holding-down piece 34 is composed of a plate piece having an L shape and is bendable substantially at right angles from a state of being straight along the Z-axis. As shown in FIG. 1, the first holding-down piece 33 is disposed parallel to the second region 24 (FIG. 3) when bent. The second holding-down piece 34 is also disposed parallel to the second region 24 when bent.

As shown in FIG. 4, the second holding-down piece 34 includes an extended portion 340. The extended portion 340 is at an extremity of the second holding-down piece 34 and has a length along the X-axis longer than that of other portions along the X-axis.

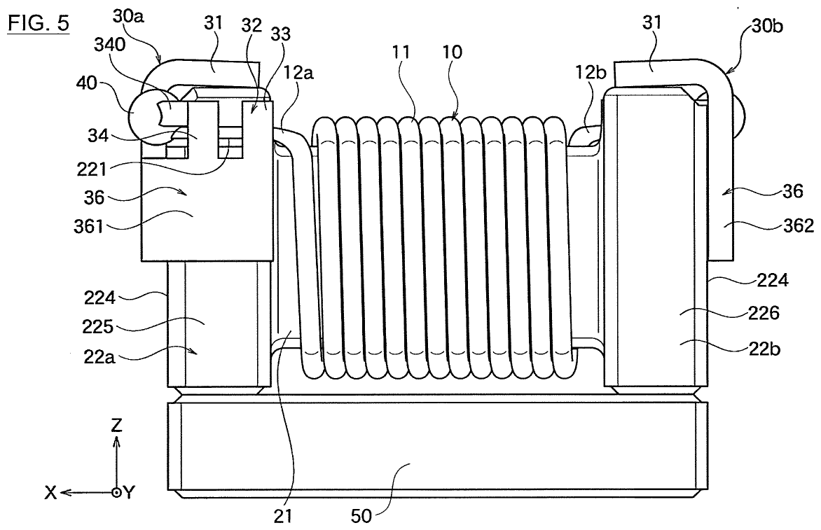

As shown in FIGS. 1 and 5, the lead-out portion 12a is at least partly disposed between the wire connecting portion 32 and the second region 24 (FIG. 3) of the mounting surface 221 and is interposed (held) between the wire connecting portion 32 and the mounting surface 221. Between the wire connecting portion 32 and the second region 24 is a gap, and the lead-out portion 12a is at least partly disposed in the gap.

The lead-out portion 12b is at least partly disposed between the wire connecting portion 32 and the second region 24 of the mounting surface 221 and is interposed (held) between the wire connecting portion 32 and the second region 24. Between the wire connecting portion 32 and the second region 24 is a gap, and the lead-out portion 12b is at least partly disposed in the gap.

The first holding-down piece 33 has a crimping structure and holds the lead-out portion 12a or 12b down towards the mounting surface 221. The second holding-down piece 34 has a crimping structure and holds the lead-out portion 12a or 12b down towards the mounting surface 221, at a location closer than the first holding-down 33 piece to the outer end surface 224. Crimping the first holding-down piece 33 and the second holding-down piece 34 allows the lead-out portion 12a or 12b to be easily held down towards the mounting surface 221. The lead-out portion 12a or 12b may be in contact with the second region 24 of the mounting surface 221, or a gap may be provided between the lead-out portion 12a or 12b and the mounting surface 221.

The lead-out portion 12a or 12b is in contact with an inner surface (surface that opposes the mounting surface 221) of the second holding-down piece 34. The lead-out portion 12a or 12b is connected to the extended portion 340 of the second holding-down piece 34 using, for example, laser welding. The second holding-down piece 34 (extended portion 340) is provided with the fusion zone 40 whereas the first holding-down piece 33 is not provided with a fusion zone. The lead-out portion 12a or 12b is in contact with an inner surface (surface that opposes the mounting surface 221) of the first holding-down piece 33; however, the lead-out portion 12a or 12b is not integrated with the first holding-down piece 33 using the fusion zone 40.

For example, holding the lead-out portion 12a down towards the mounting surface 221 using the first holding-down piece 33 before the lead-out portion 12a is connected to the second holding-down piece 34 can reduce variety in positions of the lead-out portion 12a to connect the lead-out portion 12a to a desired point in the second holding-down piece 34. Also, holding the lead-out portion 12a down towards the mounting surface 221 using the second holding-down piece 34 allows the lead-out portion 12a to connect to the second holding-down piece 34 while contact between the lead-out portion 12a and the second holding-down piece 34 is ensured. The same applies to the lead-out portion 12b.

As shown in FIG. 4, the intermediate portion 36 is a portion connecting the mounting portion 31 and the wire connecting portion 32. One end of the intermediate portion 36 in its extending direction is continuously connected to an outer end of the mounting portion 31 in the X-axis direction. The other end of the intermediate portion 36 in its extending direction is continuously connected to respective ends (roots) of the first holding-down piece 33 and the second holding-down piece 34.

As shown in FIGS. 3 and 4, the intermediate portion 36 is bent in an L shape at a point (ridge portion) where the first side surface 225 and the outer end surface 224 meet and has an L shape (a bent structure) in plan view. The intermediate portion 36 includes a side-surface opposing portion 361 and an end-surface opposing portion 362 orthogonal to the side-surface opposing portion 361. As shown in FIG. 5, the side-surface opposing portion 361 is disposed over the first side surface 225 so as to oppose the first side surface 225. The side-surface opposing portion 361 is in contact with the first side surface 225; however, a gap may be provided between the side-surface opposing portion 361 and the first side surface 225. The side-surface opposing portion 361 may have any length along the Z-axis; and this length is not more than half the length of the first side surface 225 along the Z-axis.

The first holding-down piece 33 and the second holding-down piece 34 extend from one end of the side-surface opposing portion 361 in the Z-axis direction so as to stand therefrom. Between the side-surface opposing portion 361 and the first side surface 225, no adhesive is used.

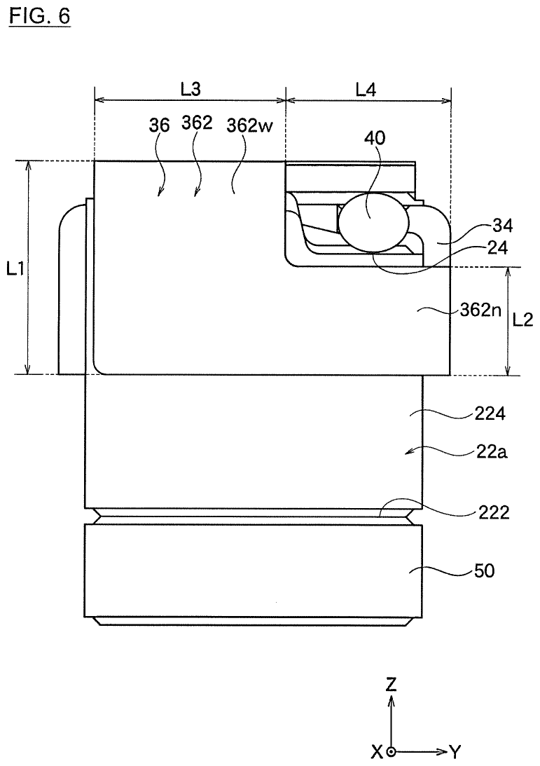

As shown in FIG. 6, the end-surface opposing portion 362 is disposed over the outer end surface 224 so as to oppose the outer end surface 224. The end-surface opposing portion 362 has an L shape (a bent (curved) structure) viewed from the X-axis direction.

The end-surface opposing portion 362 is in contact with the outer end surface 224; however, a gap may be provided between the end-surface opposing portion 362 and the outer end surface 224. The end-surface opposing portion 362 (in particular, a wide portion 362w described later) may be adhered to the outer end surface 224 using an adhesive.

The end-surface opposing portion 362 includes a wide portion 362w and a narrow portion 362n. One end of the wide portion 362w in the Z-axis direction is continuously connected to the mounting portion 31 (FIG. 4). A length L1 of the wide portion 362w in the Z-axis direction is larger than a length L2 of the narrow portion 362n in the Z-axis direction. The wide portion 362w has an area larger than that of the narrow portion 362n. The ratio of L1 to L2 (L1/L2) is not limited and may be 2 or more. The length L1 of the wide portion 362w in the Z-axis direction is not limited and may be not less than half the length of the outer end surface 224 in the Z-axis direction.

A length L3 of the wide portion 362w along the Y-axis is larger than a length L4 of the narrow portion 362n along the Y-axis. The ratio of L3 to L4 (L3/L4) is not limited and may be 1 or more. The length L3 of the wide portion 362w in the Y-axis direction is not limited and may be not less than half the length of the outer end surface 224 in the Y-axis direction.

The narrow portion 362n is adjacent to the wide portion 362w and extends along the Y-axis. The narrow portion 362n continuously connects the wide portion 362w and the side-surface opposing portion 361 (FIG. 4). The narrow portion 362n is located closer than the second region 24 to the non-mounting surface 222, over the outer end surface 224.

As shown in FIGS. 5 and 6, the intermediate portion 36 extends between the mounting portion 31 and the wire connecting portion 32 via two surfaces of the flange 22a, namely the outer end surface 224 and the first side surface 225. In other words, the intermediate portion 36 has a route extending over the two surfaces of the flange 22a, namely the outer end surface 224 and the first side surface 225, to connect the mounting portion 31 and the wire connecting portion 32. The intermediate portion 36 is bent (curved) in an L shape from the wide portion 362w to the narrow portion 362n and is bent in an L shape from the narrow portion 362n to the side-surface opposing portion 361. In such a way, the intermediate portion 36 has two bends (curves); however, the intermediate portion 36 may have three or more bends (curves). For example, in an example shown in FIG. 6, the end-surface opposing portion 362 has one bend (curve) over the outer end surface 224; however, the end-surface opposing portion 362 may have two or more bends (curves).

When the coil device 1 is mounted on a mounting substrate, a fillet (e.g., solder or conductive adhesive) may be formed at the intermediate portion 36. In this situation, the fillet can reinforce connection between the mounting portion 31 and the mounting substrate.

As shown in FIG. 5, the lead-out portion 12a is drawn out from the shaft 21 to the outer end surface 224. The same applies to the lead-out portion 12b. The fusion zone 40 is provided at an end of the extended portion 340 in the X-axis direction and is partly located outwards from the outer end surface 224 in the X-axis direction. This is because, when the lead-out portion 12a or 12b is connected to the wire connecting portion 32, the wire connecting portion 32 (second holding-down piece 34) is irradiated with a laser at an outer side of the outer end surface 224 in the X-axis direction. In this situation, damage to the flange 22a or 22b at the time of laser irradiation can be prevented.

As shown in FIG. 2, the plate-like core 50 is a plate having a rectangular parallelepiped shape and is attached to the core 20. The plate-like core 50 is composed of a material similar to the core 20 but may be composed of a material different from the core 20. As shown in FIG. 1, the plate-like core 50 is adhered to the respective non-mounting surfaces 222 of the flanges 22a and 22b using an adhesive. A peripheral portion of the plate-like core 50 is provided with a chamfering portion to prevent cracks or chips. With the plate-like core 50 being attached to the core 20, a closed magnetic circuit including the core 20 and the plate-like core 50 is formed, improving magnetic properties of the coil device 1.

Next, a method of manufacturing the coil device 1 is described. First, the wire 10, the core 20, and the terminal fittings 30a and 30b shown in FIG. 2 are prepared. The core 20 has, for example, a length of 1 to 6 mm in the X-axis direction, a length of 0.5 to 3 mm in the Y-axis direction, and a length of 0.5 to 3 mm in the Z-axis direction; however, the size of the core 20 is not limited.

Then, the mounting portion 31 of the terminal fitting 30a is adhered to the flange 22a using an adhesive to attach the terminal fitting 30a to the flange 22a. The mounting portion 31 of the terminal fitting 30b is also adhered to the flange 22b using an adhesive to attach the terminal fitting 30b to the flange 22b. At this time, as shown in FIG. 4, the first holding-down piece 33 and the second holding-down piece 34 are standing straight.

Then, as shown in FIG. 2, the wire 10 is wound around the shaft 21 to form the winding portion 11. Then, one side of the wire 10 is drawn outwards from the shaft 21 past the outer end surface 224 of the flange 22a so as to pass across the second region 24 of the flange 22a. The first holding-down piece 33 shown in FIG. 4 is bent at right angles to hold the one side of the wire 10 down towards the mounting surface 221. The one side of the wire 10 is then cut down using a cutting tool at an outer side of the outer end surface 224 in the X-axis direction. Then, the second holding-down piece 34 shown in FIG. 4 is bent at right angles to hold an end of the one side of the wire 10 down towards the mounting surface 221. At appropriate time, the film 13 of the end of the one side of the wire 10 is peeled off.

Similarly, the other side of the wire 10 is drawn outwards from the shaft 21 past the outer end surface 224 of the flange 22b so as to pass across the second region 24 of the flange 22b. The first holding-down piece 33 shown in FIG. 4 is bent at right angles to hold the other side of the wire 10 down towards the mounting surface 221. The other side of the wire 10 is then cut down using a cutting tool at an outer side of the outer end surface 224 in the X-axis direction. Then, the second holding-down piece 34 shown in FIG. 4 is bent at right angles to hold an end of the other side of the wire 10 down towards the mounting surface 221. At appropriate time, the film 13 of the end of the other side of the wire 10 is peeled off.

Then, as shown in FIG. 5, the extended portion 340 of the terminal fitting 30a is irradiated with a laser to connect the lead-out portion 12a to the extended portion 340. Similarly, the extended portion 340 of the terminal fitting 30b is irradiated with a laser to connect the lead-out portion 12b to the extended portion 340. Note that the length of the extended portions 340 in the X-axis direction is shortened by melting (by formation of the fusion zones 40). Then, the plate-like core 50 is adhered to the non-mounting surfaces 222 of the flanges 22a and 22b using an adhesive. In the above manner, the coil device 1 can be manufactured.

As shown in FIG. 1, in the coil device 1 of the present embodiment, the intermediate portion 36 has the route extending over the outer end surface 224 and the first side surface 225 of the flange 22a to connect the mounting portion 31 and the wire connecting portion 32. That is, instead of extending along a shortest route between the mounting portion 31 and the wire connecting portion 32 (a route along the mounting surface 221), the intermediate portion 36 extends along a route circumventing the shortest route (a route extending over the outer end surface 224 and the first side surface 225 of the flange 22a). Thus, compared to a situation in which the intermediate portion 36 extends along the shortest route, the intermediate portion 36 has a longer length along its extending direction, and the distance between the mounting portion 31 and the wire connecting portion 32 via the intermediate portion 36 is increased. This reduces the amount of heat transfer from the wire connecting portion 32 to the mounting portion 31 when the lead-out portion 12a is laser welded to the wire connecting portion 32, mitigating the temperature rise of the mounting portion 31. Consequently, the plating film on the surface of the mounting portion 31 is less readily degraded, and joinability of the mounting portion 31 with respect to a mounting substrate is improved, which can increase quality of joining between the mounting portion 31 and the mounting substrate.

Also, mitigation of the temperature rise of the mounting portion 31 makes the adhesive between the mounting portion 31 and the mounting surface 221 be less readily degraded. This improves joinability of the mounting portion 31 with respect to the mounting surface 221, allowing increase in quality of joining between the mounting portion 31 and the mounting surface 221.

The lead-out portion 12a is at least partly disposed between the wire connecting portion 32 and the mounting surface 221. Thus, when the lead-out portion 12a is connected to the wire connecting portion 32, the wire connecting portion 32 or the mounting surface 221 can prevent misalignment of the lead-out portion 12a due to its elasticity. This allows the lead-out portion 12a to be connected to a desired point in the wire connecting portion 32, improving quality of joining between the lead-out portion 12a and the wire connecting portion 32.

### Second Embodiment

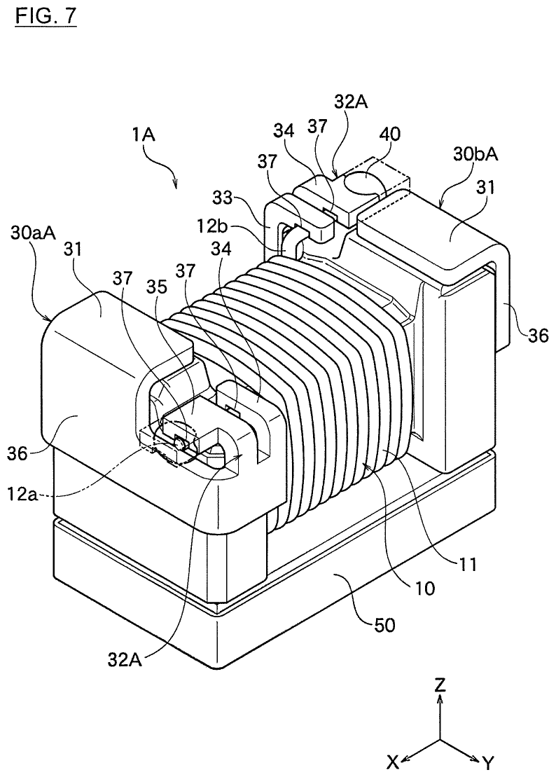

A coil device 1A of a second embodiment shown in FIG. 7 has a configuration similar to the coil device 1 of the first embodiment, except for the following. Parts common to the coil device 1 of the first embodiment are given the same reference numerals, and their detailed description is omitted.

The coil device 1A is different from the coil device 1 of the first embodiment in that the coil device 1A includes terminal fittings 30aA and 30bA. The terminal fittings 30aA and 30bA are different from the terminal fittings 30a and 30b of the first embodiment in that each of the terminal fittings 30aA and 30bA includes a wire connecting portion 32A.

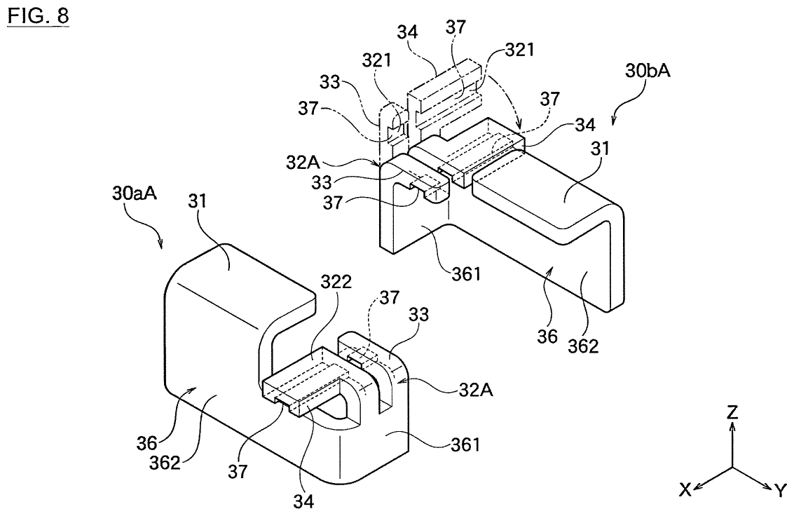

As shown in FIG. 8, the wire connecting portion 32A has a terminal groove 37. The terminal groove 37 is recessed from an inner surface 321 of each of the first holding-down piece 33 and the second holding-down piece 34 towards an outer surface 322 of each of the first holding-down piece 33 and the second holding-down piece 34. The inner surface 321 is a surface opposing the mounting surface 221, and the outer surface 322 is a surface opposite the inner surface 321.

The terminal groove 37 extends along the X-axis. More specifically, the terminal groove 37 extends linearly from one end to the other end of the first holding-down piece 33 in the X-axis direction. The terminal groove 37 also extends linearly from one end to the other end of the second holding-down piece 34 in the X-axis direction. The terminal groove 37 has a quadrilateral cross-sectional shape; however, the sectional shape may be, for example, polygonal, circular, or oval.

The terminal groove 37 has a depth smaller than the diameter of the wire 10. However, the depth of the terminal groove 37 may be equivalent to or larger than the diameter of the wire 10. As shown in FIG. 7, at least a part of the lead-out portion 12a is accommodated in the terminal groove 37 of the terminal fitting 30aA. At least a part of the lead-out portion 12b is accommodated in the terminal groove 37 of the terminal fitting 30bA.

The present embodiment also produces effects similar to those of the first embodiment.

In addition, because the at least a part of the lead-out portion 12a is accommodated in the terminal groove 37 in the present embodiment, the terminal groove 37 helps positioning of the lead-out portion 12a, reducing variety in positions of the lead-out portion 12a relative to the wire connecting portion 32A. This allows the lead-out portion 12a to be connected to a desired point in the wire connecting portion 32A, improving quality of joining between the lead-out portion 12a and the wire connecting portion 32A.

### Third Embodiment

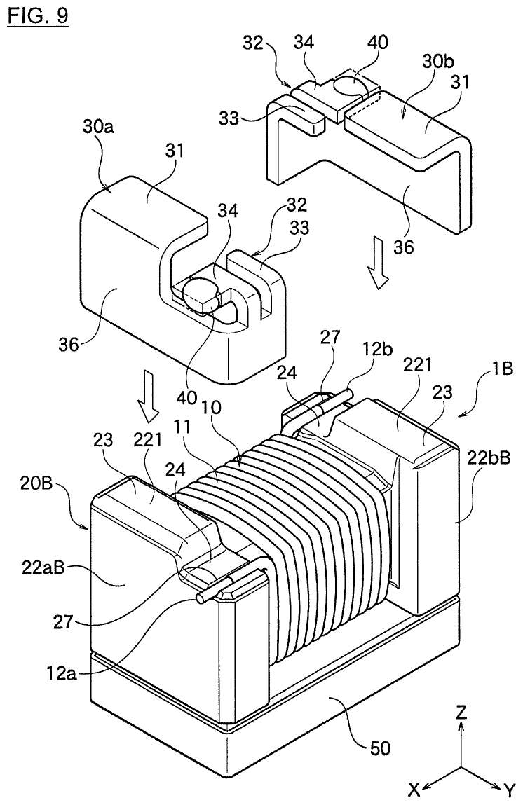

A coil device 1B of a third embodiment shown in FIG. 9 has a configuration similar to the coil device 1 of the first embodiment, except for the following. Parts common to the coil device 1 of the first embodiment are given the same reference numerals, and their detailed description is omitted.

The coil device 1B is different from the coil device 1 of the first embodiment in that the coil device 1B includes a core 20B. The core 20B is different from the core 20 of the first embodiment in that the core 20B includes flanges 22aB and 22bB.

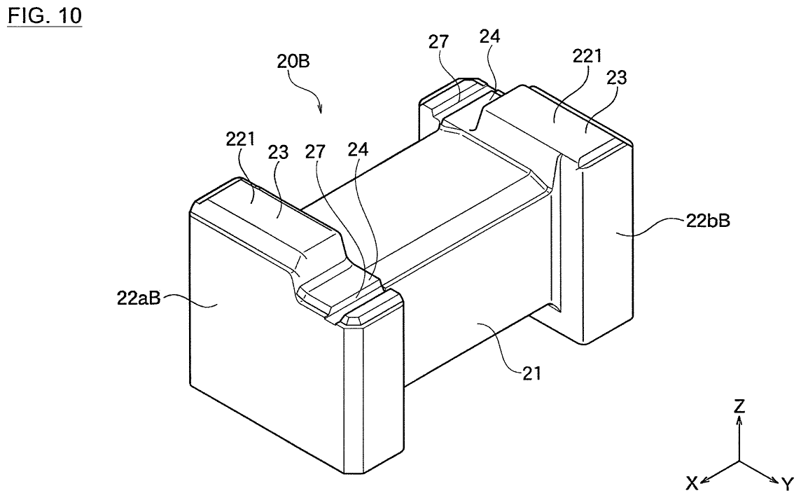

As shown in FIG. 10, the flanges 22aB and 22bB each have a flange groove 27. The flange groove 27 is provided in the second region 24 of the mounting surface 221 and extends along the mounting surface 221, at a location opposing the wire connecting portion 32 (the first holding-down piece 33 and the second holding-down piece 34) shown in FIG. 9.

The flange groove 27 extends linearly along the X-axis from one end to the other end of the mounting surface 221 in the X-axis direction. The flange groove 27 has a quadrilateral cross-sectional shape; however, the sectional shape may be, for example, polygonal, circular, or oval.

The flange groove 27 has a depth smaller than the diameter of the wire 10. However, the depth of the flange groove 27 may be equivalent to or larger than the diameter of the wire 10. As shown in FIG. 9, at least a part of the lead-out portion 12a is accommodated in the flange groove 27 of the flange 22aB. At least a part of the lead-out portion 12b is accommodated in the flange groove 27 of the flange 22bB.

The present embodiment also produces effects similar to those of the first embodiment. In addition, in the present embodiment, the at least a part of the lead-out portion 12a is accommodated in the flange groove 27. Thus, the flange groove 27 helps positioning of the lead-out portion 12a, reducing variety in positions of the lead-out portion 12a relative to the wire connecting portion 32. This allows the lead-out portion 12a to be connected to a desired point in the wire connecting portion 32, improving quality of joining between the lead-out portion 12a and the wire connecting portion 32.

### Fourth Embodiment

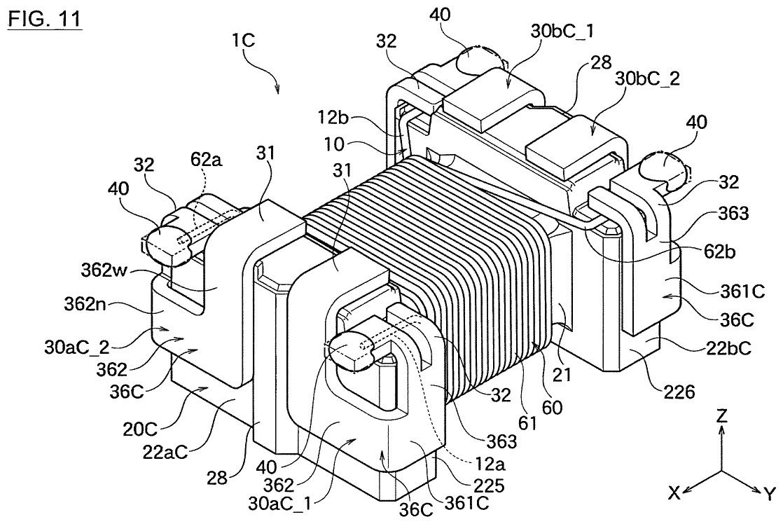

A coil device 1C of a fourth embodiment shown in FIG. 11 has a configuration similar to the coil device 1 of the first embodiment, except for the following. Parts common to the coil device 1 of the first embodiment are given the same reference numerals, and their detailed description is omitted.

The coil device 1C includes a core 20C, terminal fittings 30aC_1 and 30aC_2, and terminal fittings 30bC_1 and 30bC_2. The coil device 1C further includes a wire 60 in addition to the wire 10. The coil device 1C functions as, for example, a transformer and may be included in a power supply or the like of electronic equipment. Either the wire 10 or the wire 60 constitutes a primary side coil, and the other constitutes a secondary side coil.

The wire 60 includes a winding portion 61, which is wound in a coil shape, and lead-out portions 62a and 62b, which are drawn out from the winding portion 61. Although detailed illustration in the drawings is omitted, the wire 10 is wound around an outer circumferential surface of a shaft 21 of the core 20C to form the winding portion 11 therearound (see FIG. 2). The wire 60 is wound around an outer circumferential surface of the winding portion 11 to form the winding portion 61 therearound. However, how the wires 10 and 60 are wound is not limited to this. For example, the wire 10 may be wound around the shaft 21 at one side in the X-axis direction, and the wire 60 may be wound around the shaft 21 at the other side in the X-axis direction.

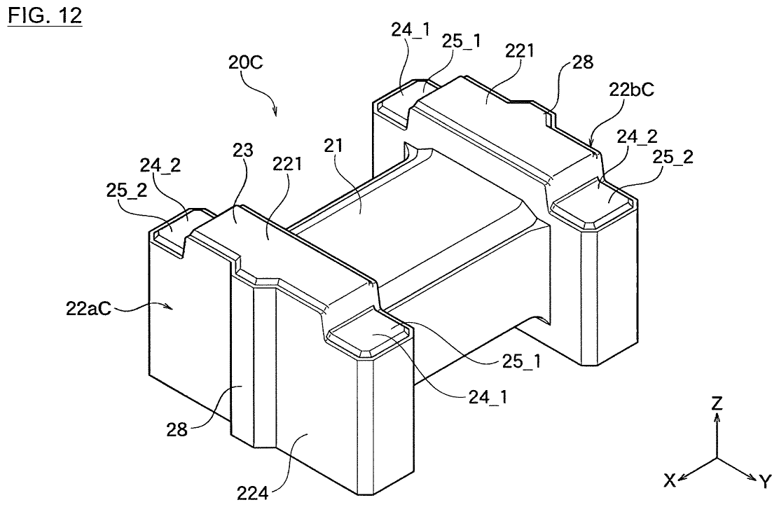

As shown in FIG. 12, the core 20C includes flanges 22aC and 22bC. Each of the flanges 22aC and 22bC has depressions 25_1 and 25_2 and a protrusion 28. The depression 251 is provided at one end of the mounting surface 221 in the Y-axis direction. The one end of the mounting surface 221 in the Y-axis direction is depressed, and the depression 25_1 is formed at this one end. The depression 252 is provided at the other end of the mounting surface 221 in the Y-axis direction. The other end of the mounting surface 221 in the Y-axis direction is depressed, and the depression 25_2 is formed at this other end.

The protrusion 28 is provided at a center of the outer end surface 224 in the Y-axis direction and extends along the Z-axis. The protrusion 28 protrudes outwards from the outer end surface 224 along the X-axis. The protrusion 28 may have any protruding length. The protruding length is larger than the thickness of the terminal fitting 30aC_1 (FIG. 11). However, the protruding length of the protrusion 28 may be equivalent to or smaller than the thickness of the terminal fitting 30aC_1. The protrusion 28 is provided with a chamfering portion or a tapering along the Z-axis to prevent cracks or chips.

As shown in FIG. 11, the protrusion 28 of the flange 22aC separates the terminal fittings 30aC_1 and 30aC_2 to insulate them from each other. The protrusion 28 of the flange 22bC separates the terminal fittings 30bC_1 and 30bC_2 to insulate them from each other.

The terminal fitting 30aC_1 is disposed closer to a first side surface 225 of the flange 22aC, and the terminal fitting 30aC_2 is disposed closer to a second side surface 226 of the flange 22aC. The terminal fitting 30bC_1 is disposed closer to a first side surface 225 of the flange 22bC, and the terminal fitting 30bC_2 is disposed closer to a second side surface 226 of the flange 22bC.

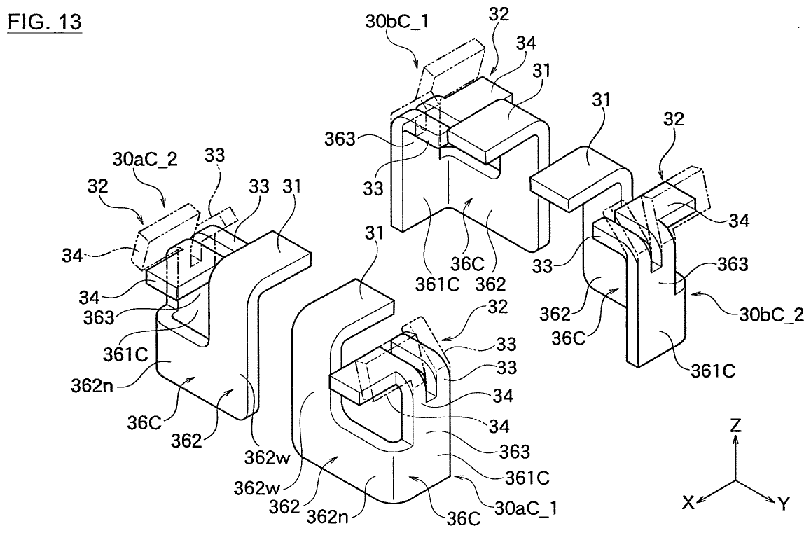

As shown in FIG. 13, each of the terminal fittings 30aC_1, 30aC_2, 30bC_1, and 30bC_2 includes an intermediate portion 36C. The intermediate portion 36C includes a side-surface opposing portion 361C, and the side-surface opposing portion 361C includes a side-surface standing portion 363. In the side-surface opposing portion 361C, the side-surface standing portion 363 is a portion located closer than the narrow portion 362n to the mounting surface 221 (FIG. 12). In other words, the side-surface standing portion 363 is a portion extending orthogonal to the narrow portion 362n. The length of the intermediate portion 36C along its extending direction is increased by the length of the side-surface opposing portion 361C along the Z-axis.

In the present embodiment, the mounting portion 31 has a length along the Y-axis shorter than the length of the mounting portion 31 of the first embodiment along the Y-axis. The wide portion 362w has a length along the Y-axis shorter than the length of the wide portion 362w of the first embodiment along the Y-axis. The wide portion 362w has a length along the Z-axis longer than the length of the wide portion 362w of the first embodiment along the Z-axis.

As shown in FIG. 11, the lead-out portion 12a is connected to a wire connecting portion 32 of the terminal fitting 30aC_1, and the lead-out portion 12b is connected to a wire connecting portion 32 of the terminal fitting 30bC_1. The lead-out portion 62a is connected to a wire connecting portion 32 of the terminal fitting 30aC_2, and the lead-out portion 62b is connected to a wire connecting portion 32 of the terminal fitting 30bC_2.

The present embodiment also produces effects similar to those of the first embodiment. In addition, in the present embodiment, the flange 22aC is provided with the two terminal fittings 30aC_1 and 30aC_2, and the flange 22bC is provided with the two terminal fittings 30bC_1 and 30bC_2. Thus, when the coil device 1C is mounted on a mounting substrate, the coil device 1C has an improved mounting stability.

Also, addition of the side-surface standing portion 363 to the side-surface opposing portion 361C increases the length of the intermediate portion 36C along its extending direction by the length of the side-surface standing portion 363. Thus, the distance between the mounting portion 31 and the wire connecting portion 32 via the intermediate portion 36C is increased, reducing the amount of heat transfer from the wire connecting portion 32 to the mounting portion 31 when the lead-out portion 12a is laser welded to the wire connecting portion 32. Also, the amount of heat transfer from the wire connecting portion 32 to the mounting portion 31 when the lead-out portion 62a is laser welded to the wire connecting portion 32 is reduced. This mitigates the temperature rise of the mounting portion 31 and makes the plating film on the surface of the mounting portion 31 be less readily degraded, improving joinability of the mounting portion 31 with respect to the mounting substrate. Also, the adhesive between the mounting portion 31 and the mounting surface 221 is less readily degraded, which improves joinability of the mounting portion 31 with respect to the mounting surface 221.

### Fifth Embodiment

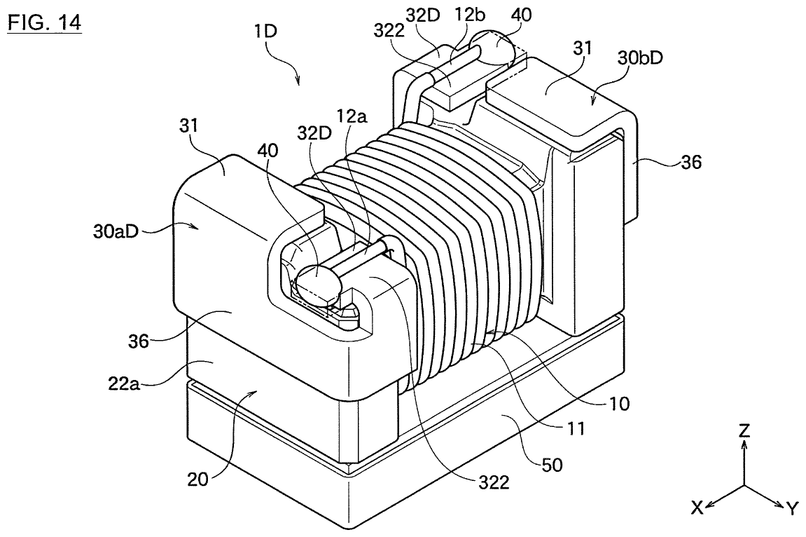

A coil device 1D of a fifth embodiment shown in FIG. 14 has a configuration similar to the coil device 1 of the first embodiment, except for the following. Parts common to the coil device 1 of the first embodiment are given the same reference numerals, and their detailed description is omitted.

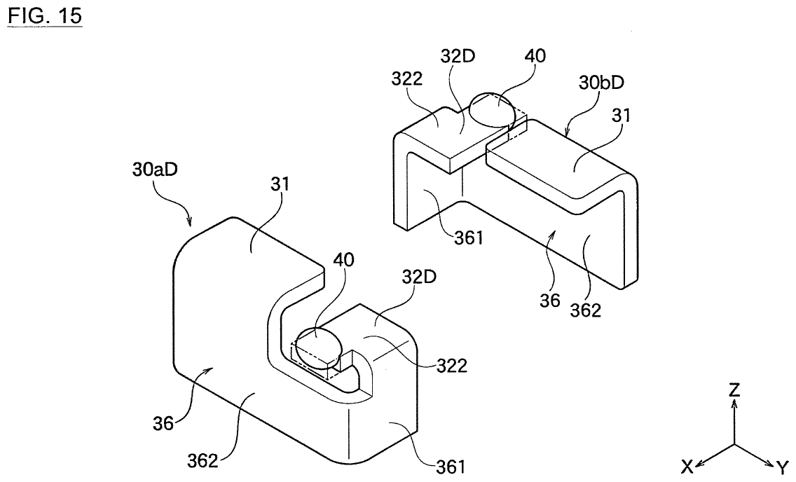

The coil device 1D is different from the coil device 1 of the first embodiment in that the coil device 1D includes terminal fittings 30aD and 30bD. As shown in FIG. 15, the terminal fittings 30aD and 30bD are different from the terminal fittings 30a and 30b of the first embodiment in that each of the terminal fittings 30aD and 30bD includes a wire connecting portion 32D. The wire connecting portion 32D is a plate parallel to the mounting surface 221 and includes neither the first holding-down piece 33 nor the second holding-down piece 34 (FIG. 4). That is, from the wire connecting portion 32D, the gap 35 of the wire connecting portion 32 (FIG. 4) of the first embodiment is omitted.

Note that, in FIG. 15, the shape of the wire connecting portion 32D after laser welding is shown in solid lines, and the shape of the wire connecting portion 32D before laser welding is shown in dashed-and-double-dotted lines.

As shown in FIG. 14, the lead-out portion 12a is drawn out linearly along the X-axis over an outer surface 322 of the wire connecting portion 32D of the terminal fitting 30aD. The lead-out portion 12a is connected to the outer surface 322 at an outer end of the wire connecting portion 32D in the X-axis direction using, for example, laser welding. The lead-out portion 12b is drawn out linearly along the X-axis over an outer surface 322 of the wire connecting portion 32D of the terminal fitting 30bD. The lead-out portion 12b is connected to the outer surface 322 at an outer end of the wire connecting portion 32D in the X-axis direction using, for example, laser welding.

The present embodiment also produces effects similar to those of the first embodiment. Additionally, when the lead-out portion 12a is connected to the outer surface 322 of the wire connecting portion 32D as in the present embodiment, a process of connecting the lead-out portion 12a to the wire connecting portion 32D is simplified.

The present invention is not limited to the above embodiments and can variously be modified within the scope of the present invention.

For example, the side-surface standing portion 363 (FIG. 13) of the fourth embodiment may be added to the side-surface opposing portions 361 of the terminal fittings 30a and 30b of the first embodiment shown in FIG. 4. The same applies to the second, third, and fifth embodiments. In this situation, the intermediate portion 36 has a longer length along its extending direction, and the distance between the mounting portion 31 and the wire connecting portion 32 via the intermediate portion 36 is increased. This reduces the amount of heat transfer from the wire connecting portion 32 to the mounting portion 31, further mitigating the temperature rise of the mounting portion 31. Thus, the effects described in the description of the first embodiment can effectively be attained.

Techniques of the second, third, and fifth embodiments may be applied to the fourth embodiment.

While the intermediate portion 36 extends in the positive direction of the Y-axis from the mounting portion 31 as shown in FIG. 1 in the first embodiment, the intermediate portion 36 may extend in the negative direction of the Y-axis from the mounting portion 31 as the terminal fitting 30aC_2 in FIG. 13 does. The same applies to the second, third, and fifth embodiments.

While the wire connecting portion 32 in the first embodiment includes the two holding-down pieces, namely the first holding-down piece 33 and the second holding-down piece 34, the wire connecting portion 32 may include a single holding-down piece. The same applies to the second embodiment to the fourth embodiment.

In the fourth embodiment, the coil device 1C may include a plate-like core 50.

### REFERENCE NUMERALS

1, 1A, 1B, 1C, 1D . . . coil device
10, 60 . . . wire
11, 61 . . . winding portion
12a, 12b, 62a, 62b . . . lead-out portion
13 . . . film
20, 20B, 20C . . . core
21 . . . shaft
22a, 22b, 22aB, 22bB, 22aC, 22bC . . . flange
221 . . . mounting surface
222 . . . non-mounting surface
223 . . . inner end surface
224 . . . outer end surface
225 . . . first side surface
226 . . . second side surface
23 . . . first region
24, 241, 24_2 . . . second region
25, 251, 25_2 . . . depression
26 . . . chamfering portion
27 . . . flange groove
28 . . . protrusion
29 . . . step
30a, 30b, 30aC_1, 30aC_2, 30bC_1, 30bC_2, 30aA, 30bA, 30aD, 30bD . . . terminal fitting
31 . . . mounting portion
32, 32A, 32D . . . wire connecting portion
321 . . . inner surface
322 . . . outer surface
33 . . . first holding-down piece
34 . . . second holding-down piece
340 . . . extended portion
35 . . . gap
36, 36C . . . intermediate portion
361, 361C . . . side-surface opposing portion
362 . . . end-surface opposing portion
362w . . . wide portion
362n . . . narrow portion
363 . . . side-surface standing portion
37 . . . terminal groove
40 . . . fusion zone
50 . . . plate-like core

What is claimed is:

1. A coil device comprising:
a wire including a winding portion and a lead-out portion drawn out from the winding portion;
a core including a shaft and a flange at one end of the shaft, the shaft having the winding portion wound around; and
a terminal fitting including a mounting portion connectable to a mounting substrate,
a wire connecting portion connected to the lead-out portion, and an intermediate portion connecting the mounting portion and the wire connecting portion, wherein
the mounting portion and the wire connecting portion are disposed over a mounting surface of the flange; and
the intermediate portion has a route extending over an end surface of the flange and a side surface of the flange to connect the mounting portion and the wire connecting portion.

2. The coil device according to claim 1, wherein
the flange has a depression in the mounting surface;
the mounting portion is outside the depression; and
the wire connecting portion is at least partly inside the depression.

3. The coil device according to claim 1, wherein the lead-out portion is at least partly disposed between the wire connecting portion and the mounting surface.

4. The coil device according to claim 1, wherein
the wire connecting portion comprises a first holding-down piece and a second holding-down piece;
the first holding-down piece holds the lead-out portion down towards the mounting surface;
the second holding-down piece holds the lead-out portion down towards the mounting surface at a location between the first holding-down piece and the end surface of the flange; and
the second holding-down piece is connected to the lead-out portion at the location.

5. The coil device according to claim 4, wherein the first holding-down piece and the second holding-down piece have a crimping structure.

6. The coil device according to claim 1, wherein
the wire connecting portion has a terminal groove accommodating at least a part of the lead-out portion, an inner surface opposing the mounting surface, and an outer surface opposite the inner surface; and
the terminal groove is recessed from the inner surface towards the outer surface.

7. The coil device according to claim 1, wherein
the flange has a flange groove accommodating at least a part of the lead-out portion; and
the flange groove opposes the wire connecting portion.

8. The coil device according to claim 1, wherein
the terminal fitting comprises a first terminal fitting and a second terminal fitting;
the first terminal fitting is closer to one side surface of the flange; and
the second terminal fitting is closer to an other side surface of the flange.

9. The coil device according to claim 1, further comprising a plate-like core attached to the core, wherein
the flange comprises a non-mounting surface opposite the mounting surface; and
the plate-like core is joined to the non-mounting surface.
